(19) United States
(12) Patent Application Publication
(10) Pub. No.: US 2023/0271115 A1
(43) Pub. Date: Aug. 31, 2023

(54) MULTIPLE FILTERING DEVICE

(71) Applicants: MURILO HAUENSTEIN RUCH, MAMBORE, PARANA (BR); ROGERIO SLOMPO, CASCAVEL, PARANA (BR)

(72) Inventors: MURILO HAUENSTEIN RUCH, MAMBORE, PARANA (BR); ROGERIO SLOMPO, CASCAVEL, PARANA (BR)

(21) Appl. No.: 18/014,634

(22) PCT Filed: Jun. 1, 2020
(86) PCT No.: PCT/BR2020/050193

§ 371 Date: Jan. 5, 2023

(30) Foreign Application Priority Data
Aug. 15, 2019 (BR) 1020190170140

(51) Int. Cl. B01D 29/58; B01D 29/60; B01D 29/96; B01D 35/147; B01D 35/143; B01D 29/15

(52) U.S. Cl. CPC B01D 29/58; B01D 29/606; B01D 29/96; B01D 35/1475; B01D 35/1435; B01D 29/15; B01D 2201/347; B01D 2201/4092; B01D 2201/301

(57) ABSTRACT

The following summary of the invention refers to the development of a multiple filtering device composed of three filtering elements (01 to 03) that are concentrically mounted on the lid (09) in the sequence EF1 (01), EF2 (02) and EF3 (03) with mesh measurements of different microns, forming four filtering chambers, with the purpose of retaining solids from agricultural spraying mixtures, monitoring the restrictive framework of the filtering elements through pressure switches (69.2) and pressure transducers (77) and alerting the obstruction through audio visual signaling (83, 83) so that the operator knows the exact moment to clean the multiple filtering device.

### TECHNICAL FIELD

The following descriptive report for the invention refers to the development of a multiple filtering device composed of three concentric filtering elements of different microns with the purpose of retaining solids from agricultural spraying mixtures, monitoring the restrictive framework of the filtering elements through pressure switches and pressure transducers and alert the obstruction through audiovisual signaling so that the operator knows the exact moment to clean the multiple filtering device.

### STATE OF THE ART

Multiple filtration systems are usual in the art, where several filters are incorporated in the same filtration device so that the fluid to be filtered passes through all the filtering elements until it leaves the already filtered device. These filters can establish in-line filtration, that is, the fluid passes through one filter, then passes through the second and so on, where the filters are not concentrically arranged.

U.S. Pat. No. 4,909,937 describes an integral filter for separating fluid components, the filter can be placed in a surrounding housing with fluid connections, the filter consisting of several tubular filter elements with different filter qualities whose cross sections are staggered in such a way that a smaller filtering element is surrounded by a larger filtering element, optionally with the formation of an intermediate space and in which the two ends of the tube are closed by closing and connection adapters and can be adapted for fluid chambers of the housing, section of the total filter can be selectively tested for integrity, provided with the emptying of fluid and filling of substances through an intermediate space between two filter elements whose intermediate space can be controlled separately and loaded from the outside.

The filtration system also has a control mechanism to avoid overpressure in the system. An example of this can be seen in US 20070199876 directed to a refrigerator water filter which describes a new fluid filtration system included, but not limited to, the frame to allow a filter cartridge to be installed and removed from a manifold with a straight-line push/pull movement, a locking mechanism and a water trap. The locking mechanism provides a unique mechanism interface between a manifold and a filter cartridge providing a compact and simple mechanism between the manifold assembly and the filter cartridge that significantly reduces the work of installing and removing fluid filter cartridges. A filter cartridge installation and removal mechanism for use by the end consumer, and the manifold assembly includes an inlet and an outlet port, the manifold assembly having a structure to maintain a substantially constant volumetric cavity of the fluid-containing fluid filtration system during filter installation and operation. This mechanism has an automatic closing system for removing the filter, where, as the inlet water pressure increases beyond a predetermined maximum desired operating pressure of the system, the inlet water will be automatically turned off, i.e. that is, it will not flow into or out of the filter cartridge.

A multilayer filter for agricultural sprayer is also described in EP 2957346 and KR 20090075945.

Other multiple filtering devices can be seen in documents U.S. Pat. Nos. 6,585,893, 3,467,256, EP 1214962, U.S. Pat. Nos. 6,267,875 and 4,954,251.

The document that comes closest to the proposed model is BR 202018073779-7, which describes a filter for triple filtration of liquids in a sprayer, within a system that is composed of an upper head that houses three filtering elements, a relief consisting of needle, sealing rings, spring, spring shim, lock nut, adjustment handle; a pressure switch, a lower head, three valves, connections, sealing rings, inlet, outlet and return connections, fixing screws, fixing nut, support, closing bar, handle, signaling to the operator that the system is under overpressure, connected to the battery cable.

### Technique Problem

The sets of filters and filtering systems described above do not include a filter to separate solid particles from fluids used in sprayers. Only conventional filters are usual, where the product to be applied goes through a simple filtering process before being sent to the spray nozzles. This simple filtering is not accurate in retaining all solid particles to the point of preventing clogging of the applicator nozzles. Conventional filters do not have a device to facilitate their opening and closing, they need external tools to make it possible to open the filter body to clean the filtering element. As there is no drainage system prior to opening, when the lid is uncoupled from the filter body, fluid spills with a high possibility of reaching the operator.

Conventional Y-shaped filters always direct the fluid jet to the same point in the filtering element mesh, causing early fatigue followed by possible rupture, thus reducing their useful life. Conventional T-shaped line filters are mounted along the bar, due to this distribution the operator needs to access several different points to perform the cleaning procedure, causing a longer time to perform the procedure.

Also, overpressure is not treated in known spraying devices, causing the risk of excess pressure in the system because they do not have a warning system for the need to clean the filtering elements, making it difficult for the operator to know the exact moment to carry out the cleaning. The consequence of this is the clogging of conventional filters causing damage to the system, premature wear of the spray pump, application failures in the field and direct contact of the operator with agricultural pesticides to clean the conventional filters. The excess of solid particles causes clogging of the spray nozzles, their cleaning is only possible manually, because of this, the execution time of this operation is long, increasing the operator's risk of poisoning by agricultural pesticides. The sum of the problems caused by the poor filtering efficiency of conventional filters can lead to the loss of the best moment for spraying, causing irreversible damage to the crop.

Because conventional filtering is not accurate in retaining all solid particles to the point of preventing clogging of the applicator nozzles, the operator is limited to using spray nozzles with larger holes, forcing himself to use a larger volume of spray solution, causing a greater expenditure of water, a less concentrated mixture, a possible lower efficiency in controlling pests/diseases, often deviating from the technical recommendation, limiting the reduction in the volume of syrup per hectare.

### Proposed Solution

Thus, due to considerations pertinent to the previously discussed state of the art, it is one of the objectives of the present invention to develop a multiple filtering device for agricultural sprayers to separate solid particles from fluids, and the multiple filtering device consists of a single access point for the operator to carry out the procedures facilitating and speeding up the process. The device consists of a surrounding casing with fluid inlet and outlet connection, three tubular filtering elements with mesh sizes of different microns arranged concentrically, that is, they are staggered in such a way that a smaller filtering element is surrounded by a smaller filtering element larger filtering device with the formation of an intermediate space between the housing, a filtering element and another called filtering chambers, forming four filtering chambers which is called the multiple filtering device, for example, a fluid to be applied through an agricultural sprayer that have multiple filtering. The fluid leaves the reservoir passing through the spray pump and then passes through the multiple filtering device, where the fluid to be filtered enters through an inlet connection that directs it to the central chamber. The jet is directed along the filtering element in order to dissipate at the bottom of the central chamber, avoiding direct pressure on the walls of the filtering element, preventing premature fatigue of the materials. When passing from the central chamber to the intramedial chamber, the fluid passes through the first filtering element with an orifice mesh 20% larger than the second filtering element that surrounds it, performing the first filtration separating the larger solid particles from the fluid, when passing from the intramedial chamber to the extramedian fluid passes through the second filtering element with an orifice mesh 20% larger than the third element that surrounds it, performing the second filtration separating the median solid particles from the fluid, in the passage from the extramedian chamber to the outlet chamber the fluid passes through the third filtering element carrying out the third filtration separating the smaller solid particles from the fluid, after this retention, the fluid, already free of solid particles, passes from the outlet chamber to the outlet connection of the multiple filtering device that follows the fluid to the spray bars and from the bars to the spray nozzles free of solid particles, avoiding the entry clogging of the same.

With the fluid free of solid particles, it is possible to select the dimensioning of spray nozzles with smaller orifices, being able to reduce the flow, increasing the concentration of the active ingredients of the syrup, increasing the autonomy of the sprayer, reducing the consumption of fossil fuel and reducing the consumption of water, obtaining thus better performance, lower cost and better spraying quality. The sum of all these factors also contributes considerably to reducing the environmental impact.

The accumulation of solid particles retained in the chambers of the multiple filtering device will cause an increase in pressure inside the system. When the pressure inside the system reaches an established limit, the pressure switches and pressure transducers send a signal to the audiovisual signaling system, which will alert the equipment operator through an audible and visual signal, identifying the exact moment to clean the elements filters. This established limit can be adjusted according to the needs of each situation. To carry out cleaning, the operator must open the drainage valves arranged on the lid. The multiple filtering device has three valves for draining the fluid prior to opening the lid, the first is responsible for discharging waste from the central chamber, the second is responsible for discharging waste from the intramedial chamber and the third is responsible for discharging waste of the extramedian chamber. If this cleaning is not enough, the operator must open the system. To open the lid, it is recommended to drain the system through the drain valves, as this will prevent fluid spillage on the operator. For opening, closing and positioning the lid of the multiple filtering device, an innovative mechanism was developed, which allows handling without the need for an external tool to remove the filtering elements and perform manual cleaning.

The multiple filtering device also has a control mechanism to prevent overpressure in the system (relief valve). In case the cleaning is not carried out or there is a failure in the system, in order to have a safety both in the multiple filtering device and in the spraying equipment, the relief valve that is incorporated in the base of the body of the system releases the pressure diverting the excess of the flow of return fluid. The differential of this relief valve was the development of a needle with orifices for the passage of fluid to an antechamber between the needle and the spring impeller, with the aim of dampening the needle, stabilizing the work of the valve avoiding shaking. It also has a handle for regulating the system's working limit pressure.

### BRIEF DESCRIPTION OF THE DRAWINGS

The characterization of the present document for the invention is done by means of representative drawings of the constructive disposition applied in a multiple filtering device, in such a way that the product can be fully reproduced by appropriate technique, allowing full characterization of the functionality of the claimed object.

The descriptive part of the report is based on the elaborated figures that express the best or preferential way of realizing the product now idealized, through a detailed and consecutive numbering, where the referred numbering clarifies aspects that may be implied by the adopted representation of so as to clearly determine the protection it intended.

These figures are merely illustrative, and may vary, as long as they do not deviate from what was initially requested.

Thus, you have to:

FIG. 1 Shows two isometric views of the proposed multiple filtering device;

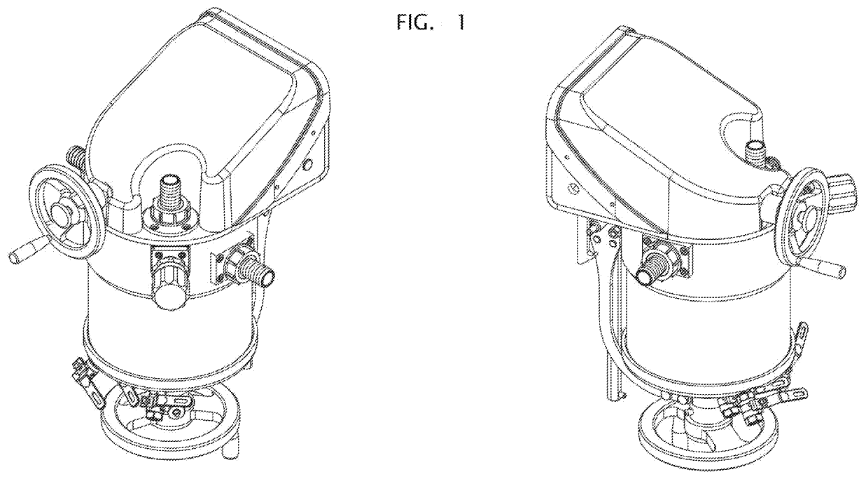

FIG. 2 Shows an exploded view of the multiple filtering device;

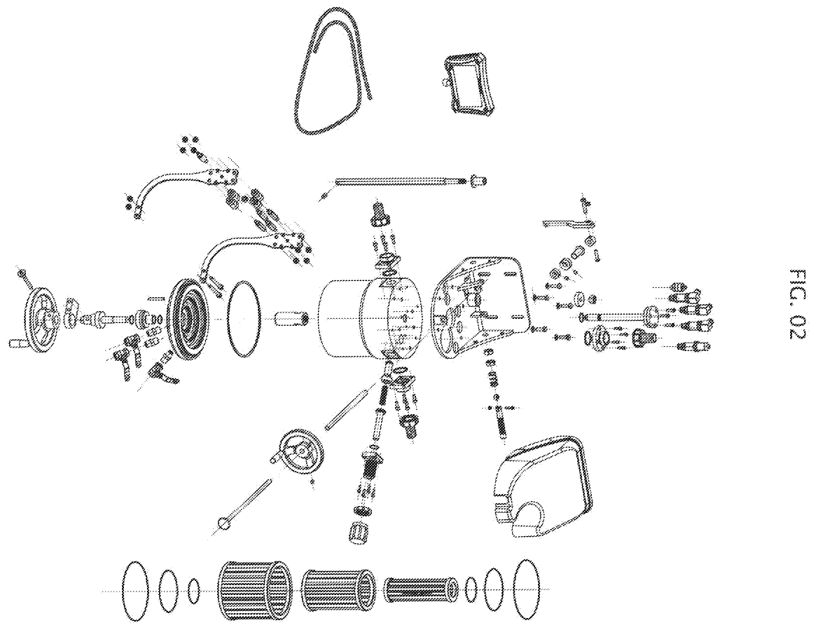

FIG. 3 Shows an exploded perspective of the device, but with the fairing over the base of the body;

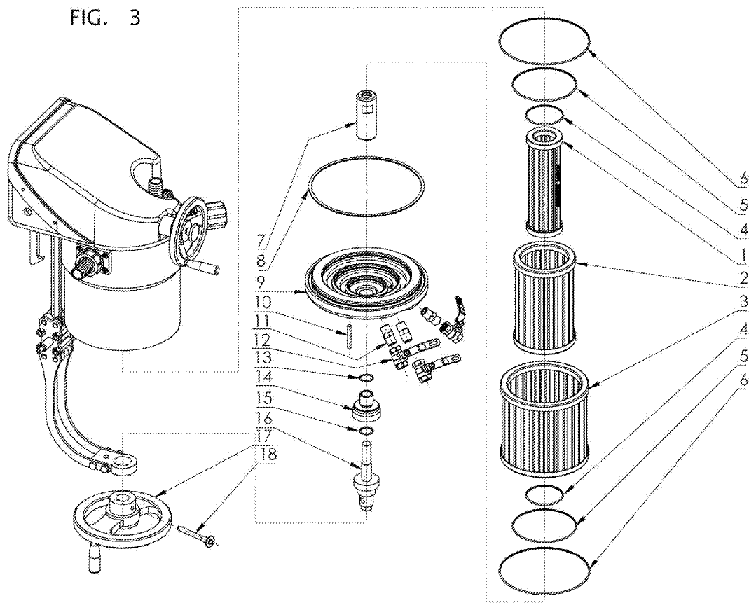

FIG. 4 Shows internal details of the base of the body, without the covering fairing;

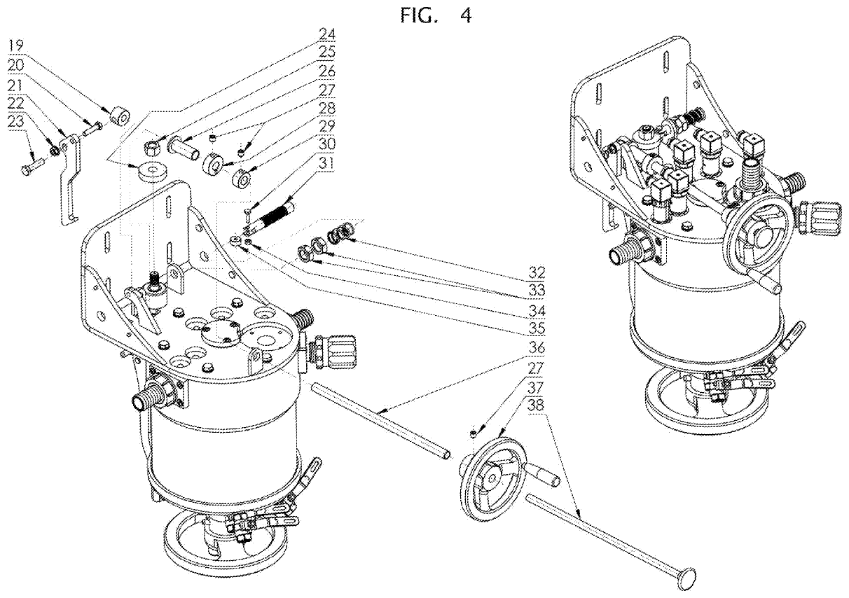

FIG. 5 Shows the means for fixing the rods to the lid;

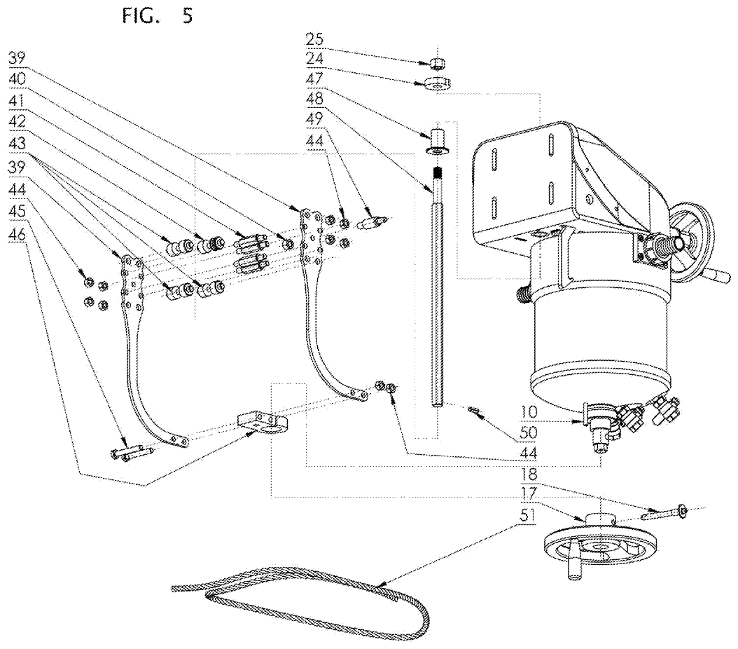

FIG. 6 Shows the inlet and outlet system and relief valve;

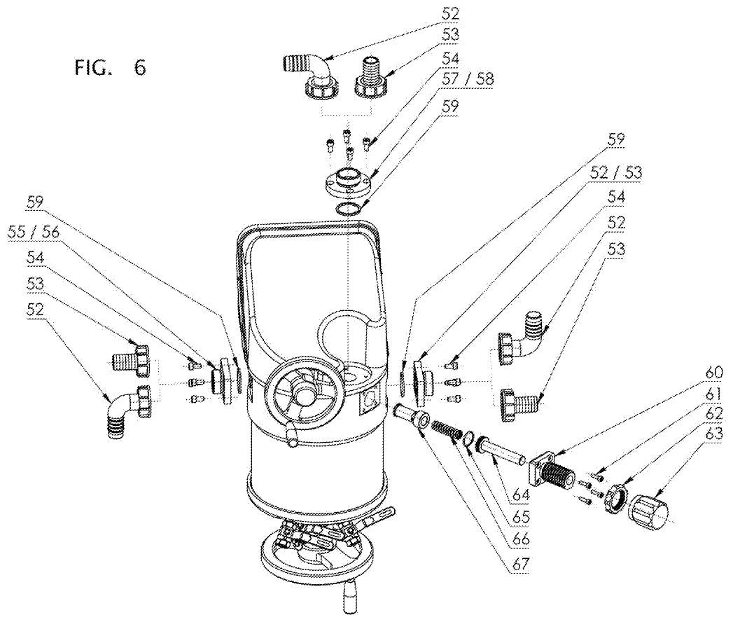

FIG. 7 Shows the base of the body; and

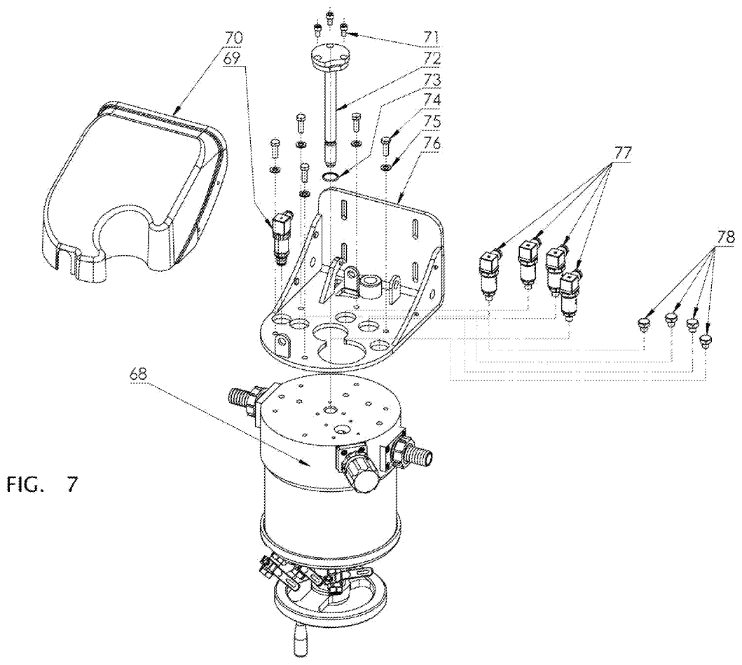

FIG. 8 Shows the connection of the filtering device with the monitor.

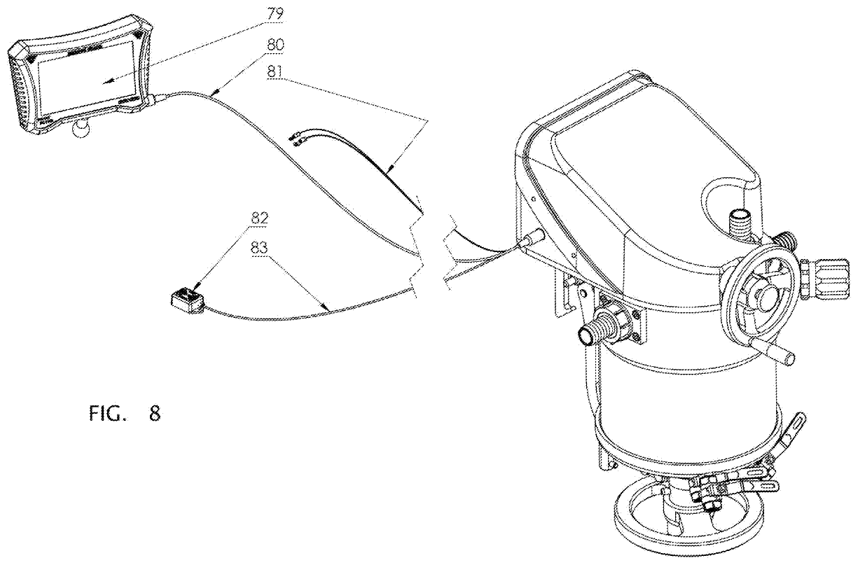

### DETAILED DESCRIPTION

The multiple filtering device is composed of 83 items including parts and components as can be seen in the figures and will be detailed below.

The filtering elements of the multiple filtering device (1 to 3) are mounted concentrically on the lid (9) in the sequence EF1 (1), EF2 (2) and EF3 (3) with mesh sizes of different microns arranged concentrically, that is, they are staggered in such a way that a smaller filtering element is surrounded by a larger filtering element with the formation of an intermediate space between the casing, a filtering element and another called filtering chambers, forming four filtering chambers which called multiple filtering.

The multiple filtering device has the function of retaining the solid particles of the fluid more efficiently, avoiding any possibility of obstruction in the spray nozzles.

The lid (7 to 10) has the function of coupling the filtering elements and seals (1 to 6) and closing the body of the device (68). The junction of the cover (09) with the body (68) forms the device's chamber. The junction of the lid (09), the body (68) and the filtering elements (01 to 06) form the four chambers of the device.

The waste discharge valves (11 and 12) are attached to the lid (9), with three valves (one for each chamber) having the function of expelling the accumulated residues in the filter element chambers (1 to 03).

Handle to lock and unlock the lid (13 to 18), where the handle facilitates the locking and unlocking of the lid without the need for the aid of tools for the same. The ring (13) seals the lid (9) and the spindle bushing (14), the ring (15) seals the spindle, spindle bushing (14) and the spindle (16), the spindle is coupled to the lid bearing (46). The locking pin (18) has a locking/unlocking device in a drive button to facilitate the decoupling of the cover (09) in case of need for cleaning, the same makes the fit between the crank (17) and the spindle (16).

Safety lock system (19 to 23, 38, 40 and 49) when the threaded sleeve (7) and the central rod (72) are uncoupled, the lid (9) is unlocked and the stop (49) is engaged to the trigger (21) limiting the sudden fall of the lid (9), to lower the lid it is necessary to press the trigger button (38).

Indexing disk (24, 25, 30 to 35) lid centering function (9) with central rod (72). The spring (32) compresses the indexing pin (31) against the indexing disk (24), the indexing disk has a channel in which, aligned with the roller (35), it reaches the locking point of the cover (09).

Lid lift (26 to 29, 36, 37) has the function of lowering the lid safely to clean the filtering elements, when necessary, and raising the lid to lock it.

Lid rod (39 to 51) lid rod assembly (39), guide roller (43), guide roller with groove (42), guide roller spacers (41), cover bearing (46), guide rod (48) and the guide rod pivot bushing (47) allow lateral displacement of the lid to remove the filtering elements.

The lid lifting cable (51) at one end is fixed to the base of the body (76), its other end is fixed to the cable holder (28), its segment passes through the guide roller with channel (42) and when turning the crank (37) the cable will wind on the reel (26).

Inlet and outlet system (52 to 56), where the fluid passes from the pump to the multiple filtering device through the inlet and outlet connection and from the system to the spray equipment segments.

In the event of obstruction of the filtering elements, the device has a relief valve (60 to 67) that prevents the device from having excess pressure by diverting excess fluid from the body of the device (68) through the return to the spray tank. The relief valve needle (67) has holes with the function of passing fluid to an antechamber between the needle and the relief valve spring tensioner (64), in order to dampen the relief valve needle (67) making it stabilize the work of the valve, avoiding vibration. Also, it has a relief valve adjustment handle (63) for regulating the working pressure limit of the system.

Body of the multiple filtering device (68) with the lid junction (9) and the filtering elements (1 to 6) form four filtering chambers in the device. Accommodates the central rod (72) which has the function of locking the lid (09), audio sound pressure switch (69.1) with the function of monitoring the obstruction of the device and alerting, through audible and visual signal (82, 83), the need device cleaning.

Vision pressure switch (69.2), when the operator activates the spray pump, it will cause a pressure in the system which will activate the pressure switch activating all the electronic components for the operation of the system, not requiring manual activation, in the same way when the operator turns off the spray pump, the lack of pressure will shut down the system.

Pressure transducers (77) reads the system pressure and transmits data to the monitor (79).

Base of the body of the multiple filtering device (71 to 76) support function of the sprayer is responsible for attaching the body of the system (68) to the base of the body (76) together with the fairing (70) form an environment protected to accommodate the system's sensors.

Monitor (79) has the function of monitoring in real time the work of the multiple filtering device.

Through the monitor (79 to 81), it is possible to visualize in percentage the obstruction of the filtering elements (1, 2 and 3), and to monitor the working pressure of the inlet and outlet system of the mixture (52 to 56), in addition to alerting, through sound and visuals, the need to clean the device.

What is claimed is:

1- A multiple filtering device, where the filtering elements of the multiple filtering device (01 to 03) are mounted on the lid (09) in the sequence EF1 (01), EF2 (02) and EF3 (03) with mesh measurements of different microns arranged in a concentric shape, forming four filtering chambers, characterized by having an electronic monitoring system (71 to 81) to control the multiple filtering device, which has pressure transducers (77) that transmit the data to a monitor (79), where, through the monitoring system (79 to 81), it is possible to visualize the obstruction of the filtering elements (1, 2 and 3) in percentage and to monitor the working pressure of the inlet and outlet system of the mixture (52 to 56).

2- The multiple filtering device, according to claim 1 and characterized by the lid (07 to 10) coupling the filtering elements and seals (01 to 06) and closing the body of the device (68), where the junction of the lid (09) with the body (68) it forms the device's chamber and the lid junction (09), the body (68) and the filtering elements (01 to 06) form the four chambers of the device.

3- The multiple filtering device, according to claim 2 and characterized by the registers (11 and 12) for the discharge of residues accumulated in the chambers of the filtering elements (01 to 03) being fixed in the lid (09), three registers (one for each chamber).

4- The multiple filtering device, according to claim 3 and characterized in that it has a sealing ring (13) between the lid (9) and the swivel bushing (14), a sealing ring (15) between the swivel bushing of the spindle (14) and the spindle (16), said spindle coupled to the cover bearing (46), where the lock pin (18) has a lock/unlock device in a drive button for decoupling the lid (09) and for the fit between the crank (17) and the spindle (16).

5- The multiple filtering device, according to claim 5 and characterized in that the lid crank (13 to 18) allows locking and unlocking the lid without using tools.

6- The multiple filtering device, according to claim 5 and characterized in that it has a safety lock system (19 to 23, 38, 40 and 49) for the decoupling between the threaded sleeve (07) and the central rod (72), with unlocking of the lid (09) and the stop (49), where it is coupled to the trigger (21) limiting the sudden fall of the lid (09).

7- The multiple filtering device, according to claim 6 and characterized in that it has an indexing disc (24, 25, 30 to 35) for centering the lid (09) with the central rod (72), containing the spring (32) that compresses the indexing pin (31) against the indexing disk (24), where the indexing disk (24) has a channel in which, being aligned with the roller (35), it reaches the locking point of the lid (09).

8- The multiple filtering device, according to claim 7 and characterized in that it has a lid lift assembly (26 to 29, 36, 37).

9- The multiple filtering device, according to claim 8 and characterized in that the lid rod assembly (39 to 51) is composed of the lid rod (39), guide roller (43), guide roller with channel (42), roller spacers guide (41), lid bearing (46), guide rod (48) and guide rod rotation bushing (47), where the lid lifting cable (51), at one end, is fixed to the base of the body (76), its other end is attached to the cable holder (28), its segment passes through the guide roller with a channel (42) and when turning the crank (37) the cable will wind itself on the reel (26).

10- The multiple filtering device, according to claim 9 and characterized in that it has a fluid inlet and outlet system (52 to 56), where the fluid passes from the pump to the multiple filtering device through the inlet and outlet connection and the system for the spray equipment segments.

11- The multiple filtering device, according to claim 10 and characterized in that the device has a relief valve (60 to 67) for overpressure of the device body (68), said relief valve containing a needle (67) provided with holes for passage of fluid to an antechamber between the needle and the relief valve spring tensioner (64); it also has a relief valve adjustment handle (63).

12- The multiple filtering device, according to claim 11 and characterized in that the body of the multiple filtering device (68) with the junction of the lid (09) and the filtering elements (01 to 06) form the four filtering chambers, with a central rod (72) for locking the lid (09), sound and audio pressure switch (69.1) to monitor device obstruction and audible and visual signaling (82, 83).

13- The multiple filtering device, according to claim 12 and characterized in that it has a vision pressure switch (69.2), pressure transducers (77) for reading the system pressure with data transmission to the monitor (79).

14- The multiple filtering device, according to claim 1 and characterized in that the base of the body of the multiple filtering device (71 to 76) fixes the body of the system (68) to the base of the body (76) together with the fairing (70).
